(19) United States
(12) Patent Application Publication
(10) Pub. No.: US 2004/0254982 A1
(43) Pub. Date: Dec. 16, 2004

(54) Receiving system for video conferencing system

(76) Inventors: Robert G. Hoffman, Fremont, CA (US); Edward V. Bacho, Sunnyvale, CA (US); Stanley P. DeMarta, Pleasanton, CA (US); Edward Burfine, Half Moon Bay, CA (US); Edward C. Driscoll JR., Portola Valley, CA (US)

Correspondence Address: BEVER, HOFFMAN & HARMS, LLP, 1432 CONCANNON BLVD., BLDG. G, LIVERMORE, CA, 94550, US

(21) Appl. No.: 10/462,218

(22) Filed: Jun. 12, 2003

(51) Int. Cl. G06F 15/16

(52) U.S. Cl. 709/204

(57) ABSTRACT

A video conference receiving system receives a panoramic view of a meeting. The panoramic view is displayed in a panoramic window of a display unit with additional windows so that a remote participant of the meeting enjoys many of the benefits of physically attending the meeting. For example, a virtual camera window can be displayed in the display unit. The remote participant can pan the virtual camera window to view different areas of the meeting. Furthermore the remote participant can cause the virtual camera window to zoom in or zoom out to obtain the desired image. An auto-tracking window can be displayed that automatically tracks an object, such as a on-site participant of the meeting or the active speaker of the meeting. Furthermore, an application that is shared by the participants of the meeting can be displayed in an application window.

### FIELD OF THE INVENTION

The present invention relates to video conferencing systems. More specifically, the present invention relates to receiving units with display units and user interfaces for video conferencing.

### BACKGROUND OF THE INVENTION

In most office meetings, the participants of the meeting sit around a table to discuss the topic of the meeting. Each person at the meeting is able to observe the other participants at the meeting. Thus, each participant can observe the facial expressions, interaction, side conversations, etc. of the other participants of the meeting. A remote participant who cannot physically attend the meeting can usually take part in the meeting using teleconferencing, which provides two way audio signals between the remote participant and the on-site participants, who are physically attending the meeting. However, without the ability to visually observe the on-site participants at the meeting, visual cues of the on-site participant at the meeting will be missed by the remote participant. Teleconferencing can also be used between two groups of people at different location. However each group will be unable to visually observer the other group.

With the advancement of networking, video, and compression technologies, video conferencing has become available for remote participants to better take part in a meeting. However, conventional video conferencing systems dramatically change the dynamics of a meeting. Rather than sitting around a table the on-site participants of a meeting are typically forced to face a camera system and a video display that is placed on one side of the meeting room. Thus, conventional video conferencing systems interfere with the normal dynamics of a live meeting because the participants of the meeting are facing a video screen on one side of the room rather than each other.

Hence there is a need for a video conferencing system that allows remote participants to take part in a meeting without interfering with the dynamics of normal meetings.

### SUMMARY

Accordingly, a video conferencing system in accordance with the present invention, provides remote participants a display unit and user interface which allows the remote participant to observe the on-site participants of a meeting as if the remote participant were sitting at the same table as the on-site participants. Specifically, a table-top video conference system is used to capture a panoramic view of the on-site participants of the meeting. The panoramic view is transmitted to the video conference systems of remote participants. A video view of the remote participants can also be transmitted to the table-top video conference system and displayed so that the on-site participants can visually observe the remote participants. In one embodiment of the present invention a display unit displays the panoramic view of the participants of the meeting in a panoramic window and one or more virtual camera views in one or more virtual camera windows. The remote participant can use the user interface to pan the virtual camera view around the meeting, to zoom in or zoom out the virtual camera view, and select the center of the virtual camera view from the panoramic view.

In addition, an auto-tracking window can be displayed on the display unit. The auto-tracking window is configured to display a particular object from the panoramic view. In some embodiments of the present invention, the receiving system receives object tracking data for the auto-tracking window. In other embodiments, an object tracking unit performs object tracking on the panoramic view to generate object tracking data. Auto-tracking windows are often used to track the active speaker during the meeting.

To encourage collaboration between meeting participants (both on-site participants and remote participants) applications can be displayed in an application window. Both on-site participants and remote participants can be the application controller. When the remote participant is the application controller application control signals from the user interface of the remote participant are transmitted to the application. Placing the display technology in the center of the conference table enables this collaboration because every participant is within reach of the user interface.

For meetings between two groups, i.e. a local group and a remote group, of participants, the remote conference table is captured and displayed in a panoramic window on the display unit(s) in the center of the local conference table. Similarly the local conference table is captured and displayed in a panoramic window on the display units(s) in the center of the remote conference table. Additional windows such as virtual camera windows, auto-focus windows, and application windows, can also be displayed on the local and remote display unit(s). Thus, Eye movement, the reading of body language, and normal meeting dynamics are preserved.

The present invention will be more fully understood in view of the following description and drawings.

### BRIEF DESCRIPTION OF THE DRAWINGS

FIG. 1(a) is an overhead view of meeting with a video conferencing system in accordance with an embodiment of the present invention.

FIG. 1(b) is a side view of a meeting with a video conferencing system in accordance with an embodiment of the present invention.

FIG. 2(a) is a 3-D illustration of the image captured by a video conferencing system in accordance with one embodiment of the present invention.

FIG. 2(b) illustrates a rectangular image format used by a video conferencing system in accordance with an embodiment of the present invention.

FIG. 2(c) illustrates an annulus image format captured by a video conferencing system in accordance with an embodiment of the present invention.

FIG. 3 is a simplified block diagram of a video conferencing system in accordance with one embodiment of the present invention.

FIG. 4(a) illustrates a display unit having a panoramic window and a virtual camera window in accordance with one embodiment of the present invention.

FIG. 4(b) illustrates a display unit having a panoramic window and a virtual camera window in accordance with one embodiment of the present invention.

FIG. 4(c) illustrates a display unit having a panoramic window and a virtual camera window in accordance with one embodiment of the present invention.

FIG. 4(d) illustrates a display unit having a panoramic window, a virtual camera window, and a control window in accordance with one embodiment of the present invention.

FIG. 5(a) illustrates a display unit having a panoramic window and two virtual camera windows in accordance with one embodiment of the present invention.

FIG. 5(b) illustrates a display unit having a panoramic window and four virtual camera windows in accordance with one embodiment of the present invention.

FIG. 6 illustrates a display unit having two panoramic windows in accordance with one embodiment of the present invention.

FIG. 7(a) illustrates a display unit having a panoramic window, a virtual camera window, and an auto-tracking window in accordance with one embodiment of the present invention.

FIG. 7(b) illustrates a display unit having a panoramic window, a virtual camera window, and an auto-tracking window in accordance with one embodiment of the present invention.

FIG. 8 illustrates a display unit using status markers in a panoramic window in accordance with one embodiment of the present invention.

FIG. 9(a) illustrates a display unit having a panoramic window and an application window in accordance with one embodiment of the present invention.

FIG. 9(b) illustrates a display unit having a panoramic window with status markers and an application window in accordance with one embodiment of the present invention.

FIG. 9(c) illustrates a display unit having a panoramic window, an application window, and a visible link in accordance with one embodiment of the present invention.

### DETAILED DESCRIPTION

As explained above, conventional video conference systems are not well suited for the way people typically have meetings. Specifically, on-site participants of a meeting using conventional video conferencing systems are forced to face a video display rather than gathering around a table. Furthermore, remote participants of the meeting are not provided the same level of visual observation as on-site participants. Accordingly, the present invention takes advantage of a table top video conference system that captures a panoramic view of the participants of the meeting for the remote participants. Furthermore, each remote participant is provided with the capability to focus in on any area of the meeting captured by the panoramic view.

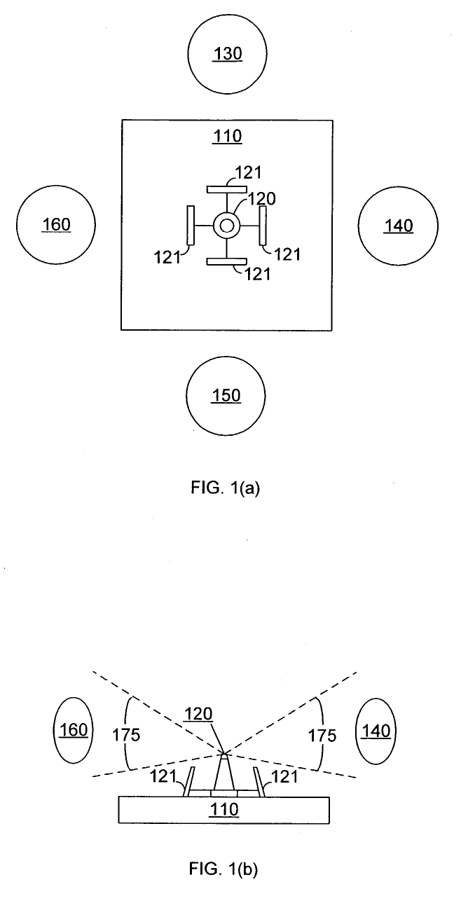

FIG. 1(a) is an overhead view of a meeting having on-site participants 130, 140, 150, and 160 (represented by circles), who are seated around a table 110. A video conferencing system 120 sits on top of table 110. Video conferencing system 120 generally includes one or more display units 121 for displaying the remote participants of the meeting. Because video conference system 120 is on table 110, on-site participants 130, 140, 150, and 160 can carry on the meeting in the same manner as meetings without remote participants. Video conferencing system 120 captures a panoramic view of the on-site participants and the environment of the meeting. FIG. 1(b) provides a side view of the meeting. In FIG. 1(b) on-site participants 130, on-site participant 150, and some of display units 121 are omitted to more clearly illustrate the view captured by video conferencing system 120. Specifically, video conferencing system 120 captures a cylindrical view of the meeting having a vertical field of view 175. The present invention can be used with a variety of video conferencing systems. For example, both the video conferencing system described in U.S. patent application Ser. No. 10/336,244, entitled “VISUAL TELECONFERENCING APPARATUS”, filed Jan. 3, 2003 by Driscoll, et. al., owned by the assignee of this application and incorporated herein by reference, and in U.S. patent application Ser. No. ______, [Attorney Docket No.: BEH-006-1P], entitled “VISUAL TELECONFERENCING APPARATUS”, filed Jun. 12, 2003 by Driscoll, et. Al., owned by the assignee of this application and incorporated herein by reference, could be used as video conference system 120.

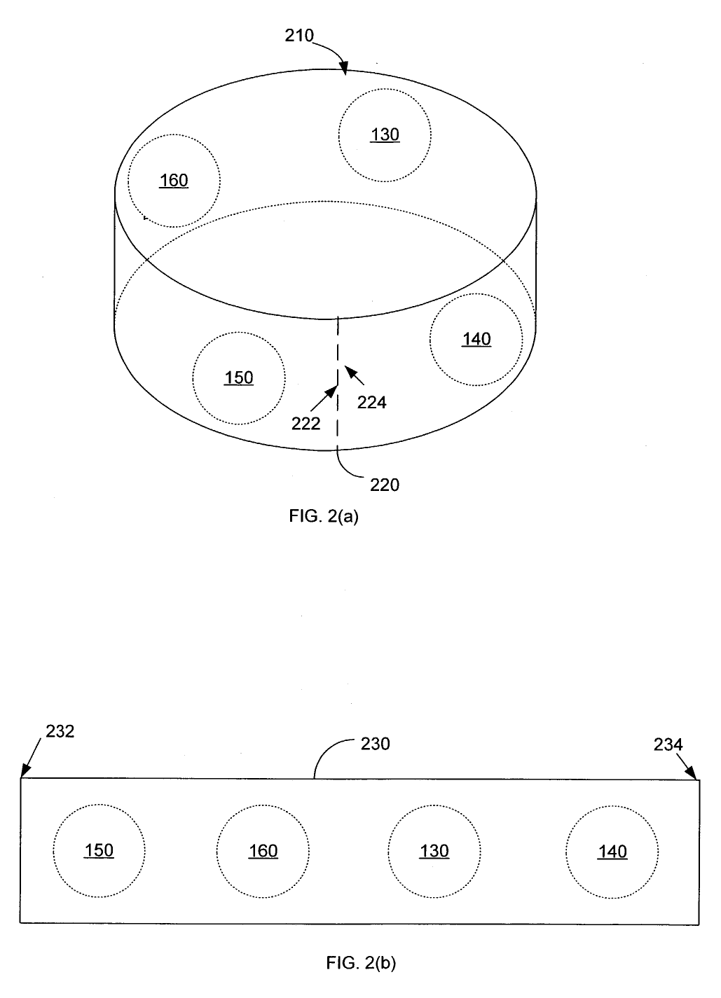

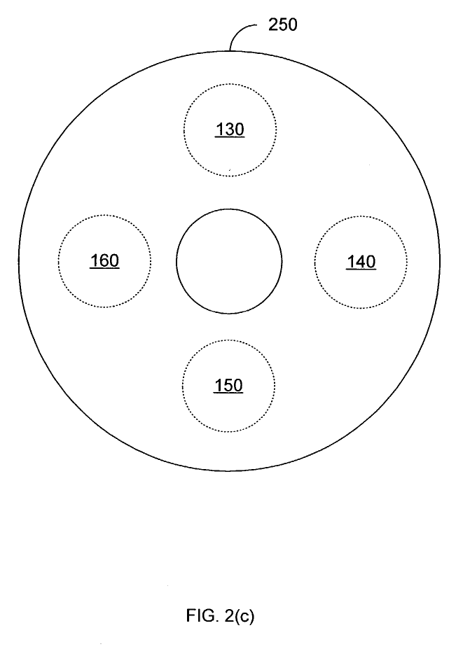

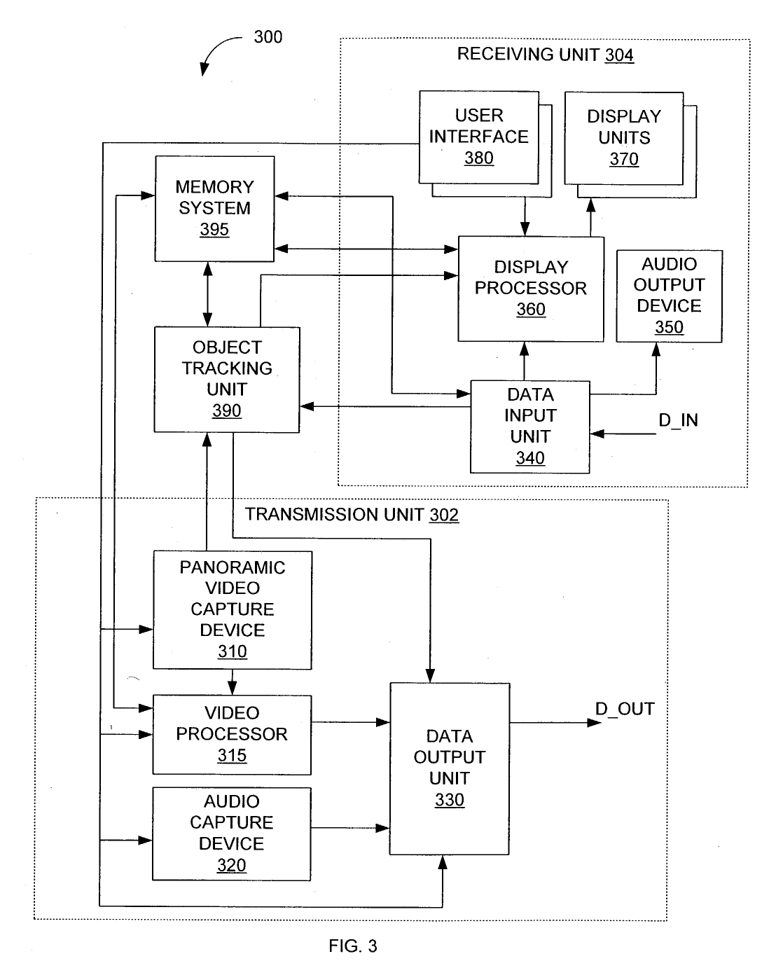

FIGS. 2(a) and 2(b) illustrate how the panoramic view captured by video conferencing system 120 processed. FIG. 2(a) illustrates a cylindrical view 210, which includes on-site participants 130, 140, 150, and 160, as captured by video conferencing system 120. Because most video processing systems are optimized to use rectangular video streams and images, cylindrical view 210 is usually unwrapped along a cut line 220, which has a left edge 222 and a right edge 224. FIG. 2(b) illustrates an unwrapped panoramic view 230 as a rectangular view 230 having a left edge 232 and a right edge 234, which correspond with left edge 222 and right edge 224 of cylindrical view 210, respectively. In unwrapped panoramic view 230, on-site participants 150, 160, 130, and 140 are arranged from right to left.

However, some embodiments of video conferencing system 120 may use different data formats for the panoramic view. For example, the panoramic view can be represented in an annular panoramic view 250 as illustrated in FIG. 2(c). In annular panoramic view 250, the location of objects (such as the on-site participants) would roughly correspond to the overhead view (as illustrated in FIG. 1(a). Thus, on-site participants 130, 140, 150, and 160 appear at the top, right side, bottom, and left side, respectively, of annular panoramic view 250. However, annular panoramic view 250 must be undistorted for viewing on standard two-dimensional display units. For example, keystone correction may be used to correct the distortion caused by the relatively low placement of video conferencing system 120 on table 110 (FIG. 1).

FIG. 3 is a simplified block diagram of a video conferencing system 300 that can be used with embodiments of the present invention. Video conferencing system 300 includes a transmission system 302 and a receiving system 304. Transmission system 302 includes a panoramic video capture device 310, a video processor 315, audio capture device 320, and a data output unit 330. Receiving unit 302 includes a data input unit 340, an audio output device 350, a display processor 360, one or more display units 370, and one or more user interfaces 380. Some embodiments of the present invention include an object tracking unit 390 and a memory system 395, which can be used by both transmission system 302 and receiving system 304. Panoramic video capture device 310 captures the panoramic view of the meeting as described above. In some embodiments of the present invention, the memory system 395 is used to store the panoramic view. Video processor 315 processes the panoramic view if necessary into a video output format such as unwrapped panoramic view 230 (FIG. 2b). In some embodiments of the present invention video processor 315 also performs video compression to reduce the amount of data that needs to be transmitted. Video processor 315 can use memory system 395 if necessary. In some embodiments of the present invention, the memory system 395 is used to store the panoramic view. The video data from video processor 315 is provided to data output unit 330. Audio capture device 320, which could be one or more microphones) captures audio data from the meeting and provides the audio data to data output unit 330. Data output unit 330 drives an output data stream D_OUT (both audio data and video data) to a data input unit of a second video conferencing system (not shown). Data input unit 340 receives input data stream D_IN (both audio data and video data) from a data output unit of the second video conferencing system (not shown). User interface 380 may be used to control features of panoramic video capture device 310 (e.g. exposure settings), video processor 315 (e.g. processing parameters), and audio, capture device 320 (e.g. volume, gain level). In addition, control signals from user interface 380 can be sent through data output unit 330.

The connection between the data input and data output units of the video conferencing systems can be for example a telephone connection, a local area network, wide area networks, or a combination of different connections. For example, in one embodiment of the present invention video data is transferred over the internet while audio data is transferred over a telephone connection. In some embodiments of the present invention a central server may receive output data stream D_OUT for transmission to one or more other video conferencing systems. Output data stream D_OUT could also be recorded by a data storage unit (not shown) for later playback.

The audio portion of input data stream D_IN is driven to an audio output device 350 (e.g. speakers, headphones). The video portion of input data stream D_IN, is provided to display processor 360 which drives one or more display units 370 based on commands from user interface 380, as described below. In some embodiments of the present invention memory system 395 is used to store input data stream D_IN for further processing by display processor 360. For example, display processor 360 may perform decompression, view selection for various windows (as described below), and object tracking.

In some embodiments of the present invention, touch screens are used so that user interface 380 is integrated with display unit 370. Some embodiments of the present invention may use a general purpose processor to perform the functions of video processor 315, display processor 360, and object tracking unit 390.

For meetings between two (or more) groups of participants, each group would likely use a video conferencing system having a panoramic video capture device. For example in a meeting between a local group of participants and a remote group of participants, the remote conference table is captured and displayed in a panoramic window on the display unit(s) in the center of the local conference table. Similarly the local conference table is captured displayed in a panoramic window on the display units(s) in the center of the remote conference table. Additional windows as described below can also be displayed on the local and remote display unit(s).

However, for meetings that include isolated remote participants, the isolated remote participants could use a video conferencing system using a non panoramic video capture device. For example, an isolated remote user could use a personal computer equipped with a web cam for video capture, a sound card (for both audio capture and audio output), the computer monitor for display unit 370, the keyboard and mouse for user interface 380, the microprocessor of the personal computer can be used for both video processor 315, display processor 360 and object tracking unit 390, the memory system of the computer can be memory system 395, and a computer network card can be used for data input unit 340 and data output unit 330.

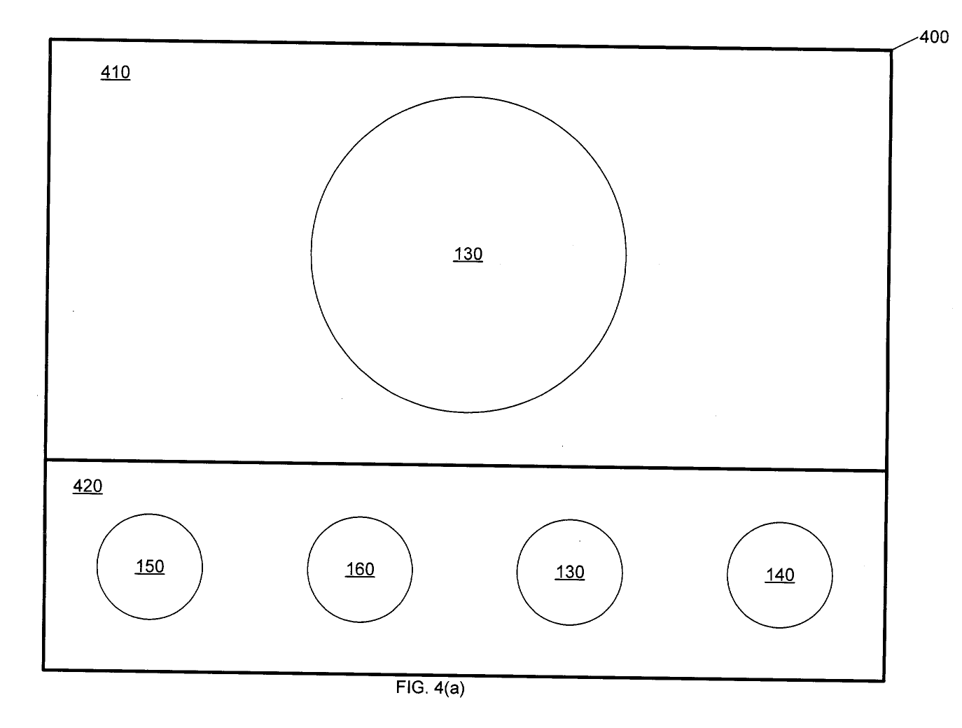

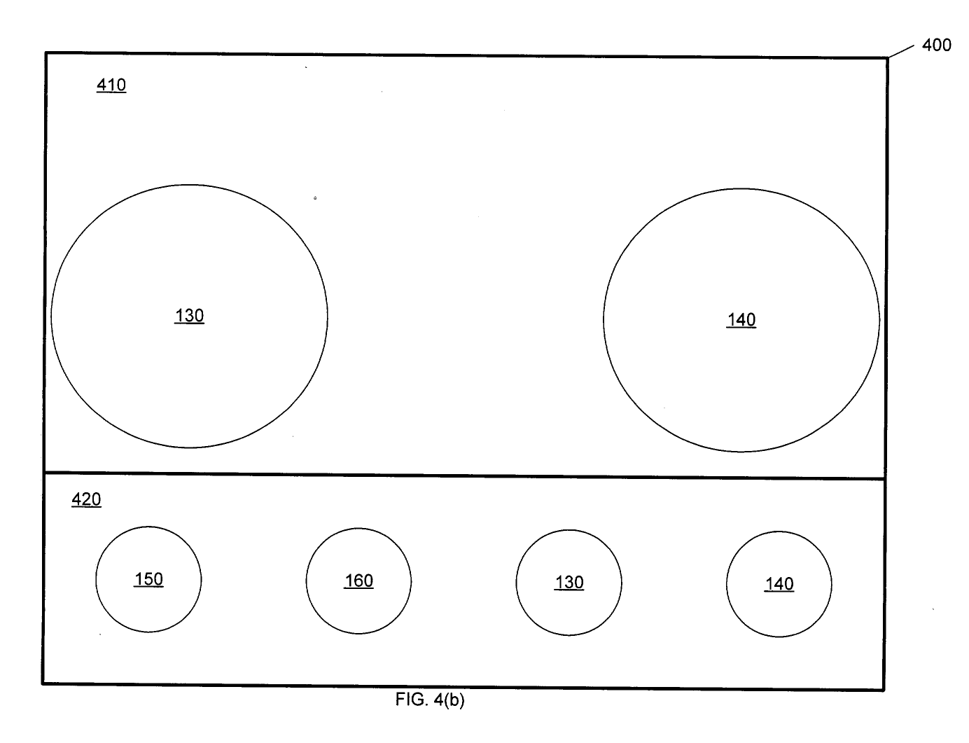

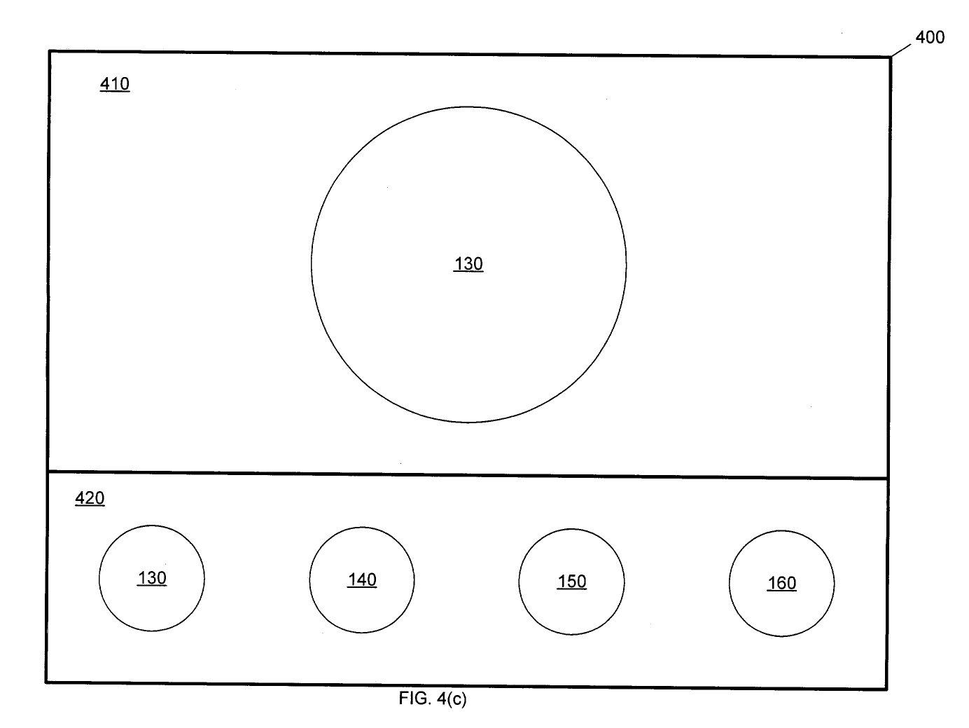

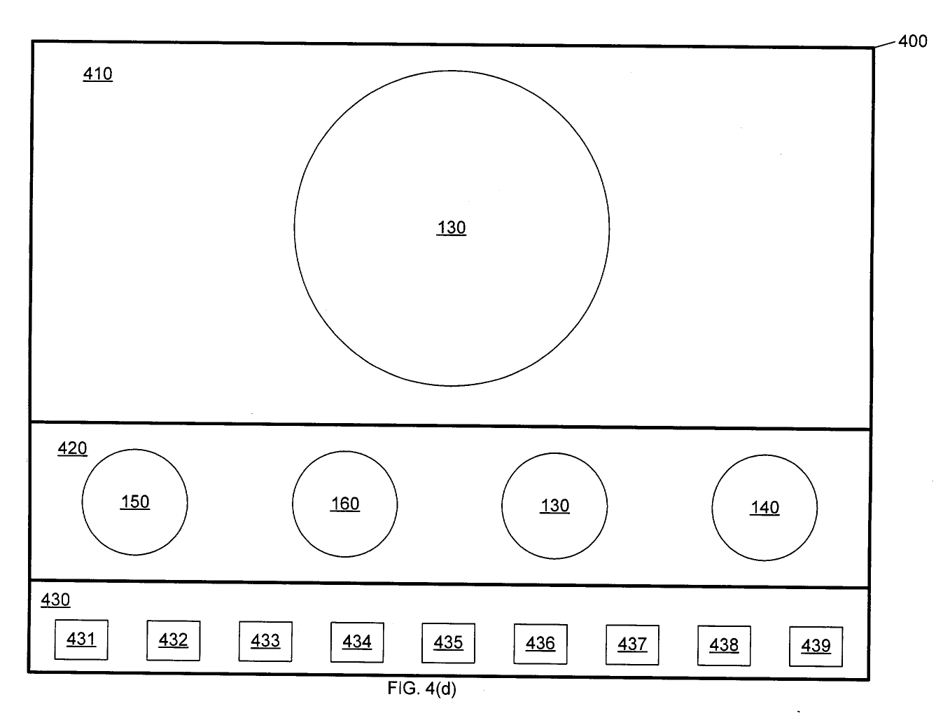

FIG. 4(a) shows a display unit 400 having a virtual camera window 410 and a panoramic window 420 in accordance with one embodiment of the present invention. Specifically, the panoramic view received in input data stream D_IN is displayed in panoramic window 420. For clarity, FIG. 4(a) is illustrated using panoramic view 230 of FIG. 2(b). Thus, on-site participants 150, 160, 130, and 140 are displayed from left to right in panoramic window 420 of display unit 400. In some embodiments of the present invention, display processor 360 is used to convert the panoramic view from input data stream D_IN (which might use for example the annular format of FIG. 2(c)) into a rectangular format. Other embodiments of the present invention may use display processor 360 to decompress video data in input data stream D_IN.

Virtual camera window 420 displays a virtual camera view of a portion of the panoramic view. In FIG. 4(a), virtual camera window 420 displays on-site participant 130. The virtual camera view of virtual camera window 420 is controlled by a user via user interface 380 (FIG. 3). Generally, the virtual camera view can be freely panned and zoomed. For example, in FIG. 4(b) the virtual camera view of virtual camera window 410 has been panned to the right and zoomed in to include both on-site participant 130 and on-site participant 140 in virtual camera window 410. Furthermore, some embodiments allow the virtual camera view to be re-centered by selecting a point on the panoramic view in panoramic window 420. In addition, some embodiments of the present invention support separate contrast and brightness settings for each window. In general user interface 380 is used to generate various control signals, such as panning control signals, a zoom out control signal, a zoom in control signal, and a centering control signal, to manipulate the virtual camera view in the virtual camera window.

In some embodiments of the present invention, a user can manipulate the panoramic view in panoramic window 410. Specifically, the user can adjust the location of cut line 220 (FIG. 2(a)). For example, FIG. 4(c) illustrates a panoramic view in panoramic window 420 with the cut line located between on-site participant 130 and on-site participant 160. Thus, on-site participants 130, 140, 150, and 160 are displayed from left to right in panoramic window 420 of display unit 400 in FIG. 4(c).

As illustrated in FIG. 4(d), in some embodiment of the present invention a control window 430 having various control buttons 431, 432, 433, . . . 439, is included on display 400. In a specific embodiment, control window 430 includes a zoom in button, a zoom out button, various preset window modes, a mute button, a dial buttons, and other control buttons.

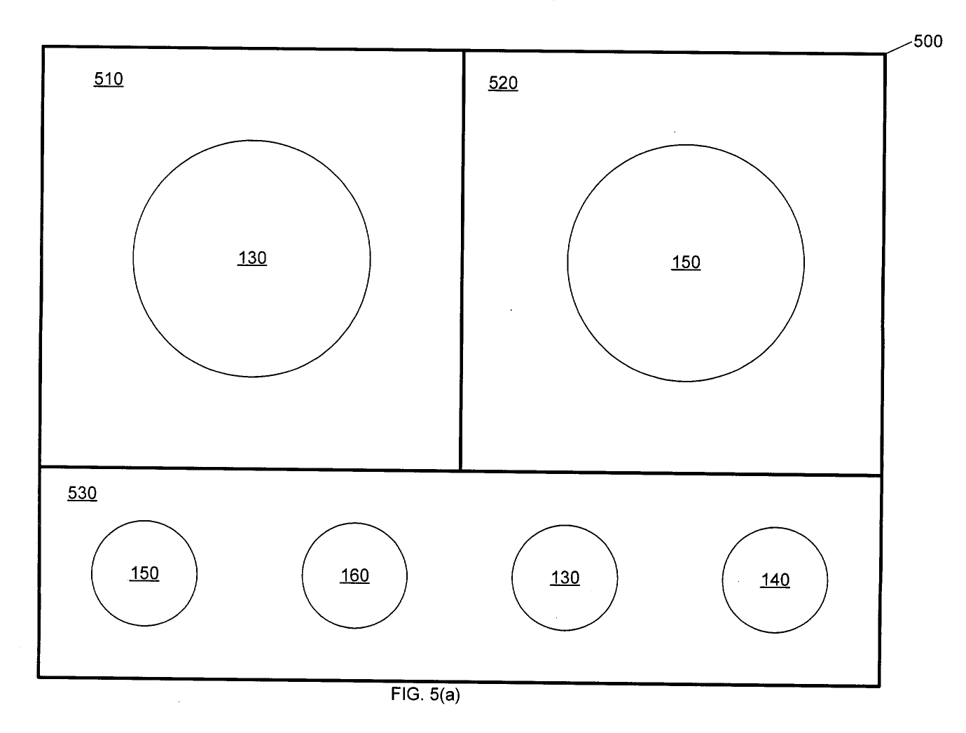

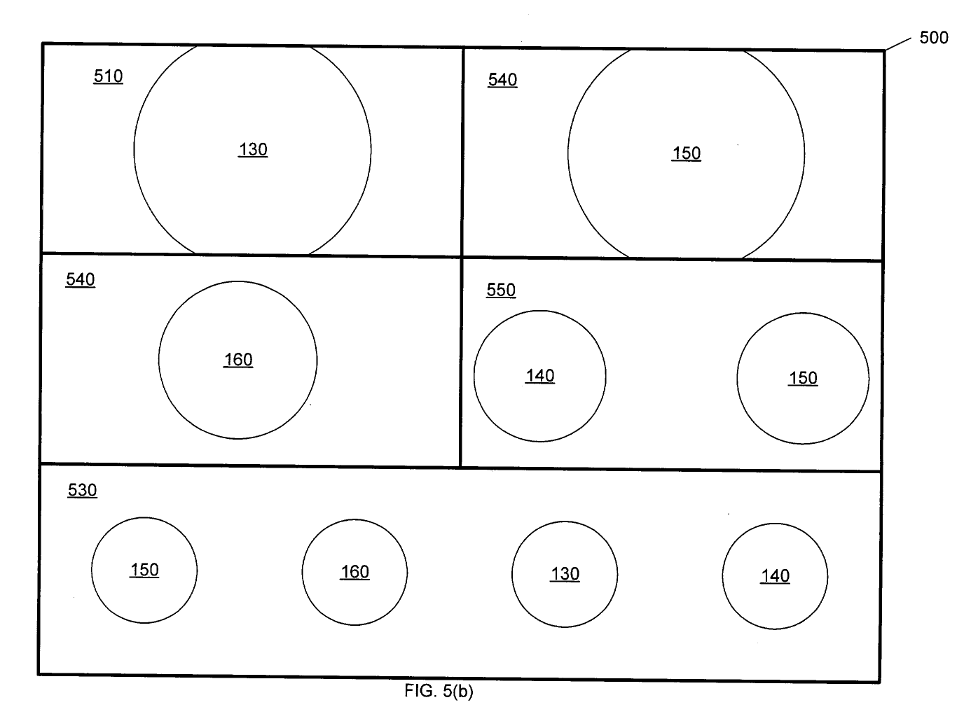

In some embodiments of the present invention, multiple virtual camera windows can be used simultaneously. For example, FIG. 5(a) illustrates a display 500 having a virtual camera window 510, a virtual camera window 520 and a panoramic window 530. For clarity, FIG. 5(a) is illustrated using panoramic view 230 of FIG. 2(b). Thus, on-site participants 150, 160, 130, and 140 are displayed from left to right in panoramic window 530 of display unit 500. Virtual camera window 510 displays on-site participant 130 and virtual camera window 520 displays on-site participant 150. A user can add additional virtual camera windows. For example, FIG. 5(b) illustrates display unit 500 after the addition of virtual camera windows 540 and 550. The virtual camera view of virtual window 540 is centered on on-site participant 160. The virtual camera view of virtual window 550 includes both on-site participants 140 and 150.

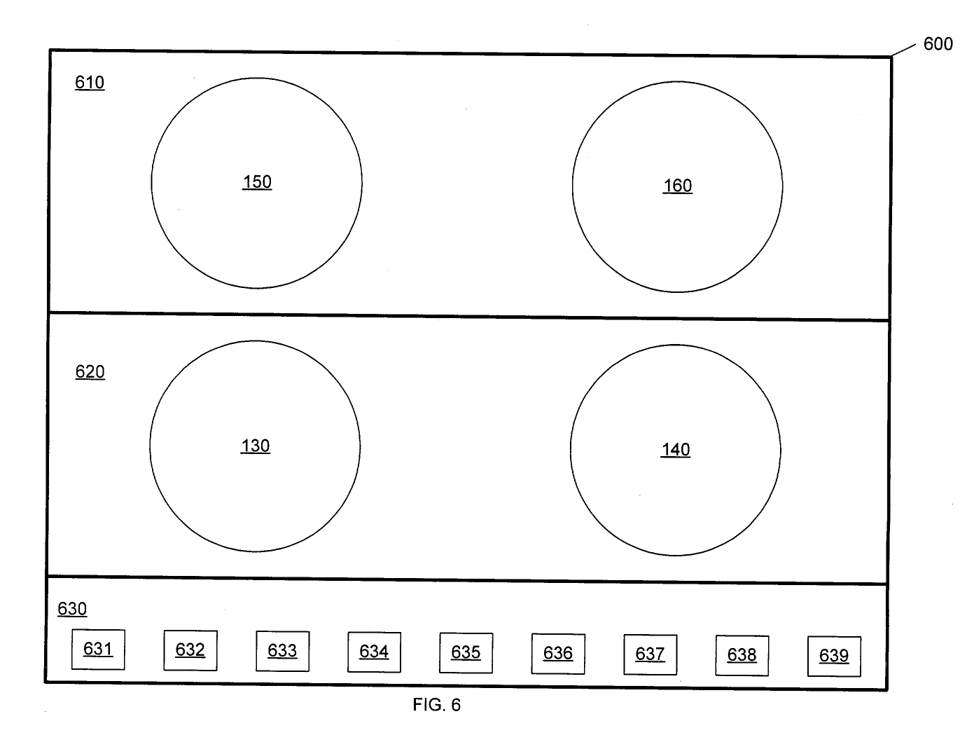

Some embodiments of the present invention also allows zooming in zooming out of the panoramic view displayed in a panoramic window. Furthermore some embodiments of the present invention supports multiple panoramic windows. FIG. 6 illustrates a display unit 600 having a first panoramic window 610, a second panoramic window 620 and a control window 630. The panoramic view of panoramic window 610 is zoomed in to include only the half of the panoramic view from input data stream D_IN that contains on-site participants 150 and 160. The panoramic view of panoramic window 620 is zoomed in to include only the half of the panoramic view from input data stream D_IN that contains on-site participants 130 and 140. Control window 630 includes various control buttons 631, 632, 633, . . . 639.

Some embodiments of the present invention also include auto-tracking windows. The view of an auto-tracking window is automatically controlled by display processor 360 to track a particular object in the panoramic view, such as an on-site participant. Conventional object detection and tracking algorithms can be performed by object tracking unit 390 to-track the movement of the desired object (including an on-site participant). If the processing that is required to determine the location of an object is performed by the video conferencing system capturing the panoramic video stream then additional object tracking data indicating the location of the object is sent through data output unit 330. Alternatively, the object tracking unit in the receiving video conferencing system could perform the processing required to locate the desired object.

In one embodiment of the present invention an auto-tracking window can be configured to display the active speaker. Determination of the active speaker can be accomplished by a variety of well-known techniques. For example, most video capture systems use multiple microphones arranged in a known spatial geometry to pick up sound from all parts of the meeting room. Triangulation techniques based on the amplitude, time-delay, and phase of the predominant voice can be used to determine the location of the active speaker. Alternatively, the video data can be analyzed to locate facial motion indicative of talking to locate the active speaker. If the processing that is required to determine the location of the active speaker is performed by the video conferencing system capturing the panoramic video stream then additional object tracking data indicating the location of the active speaker is sent through data output unit 330. Alternatively, the receiving video conferencing system could perform the processing required to locate the active speaker. When another participant begins talking the auto-tracking window switches to the new active speaker.

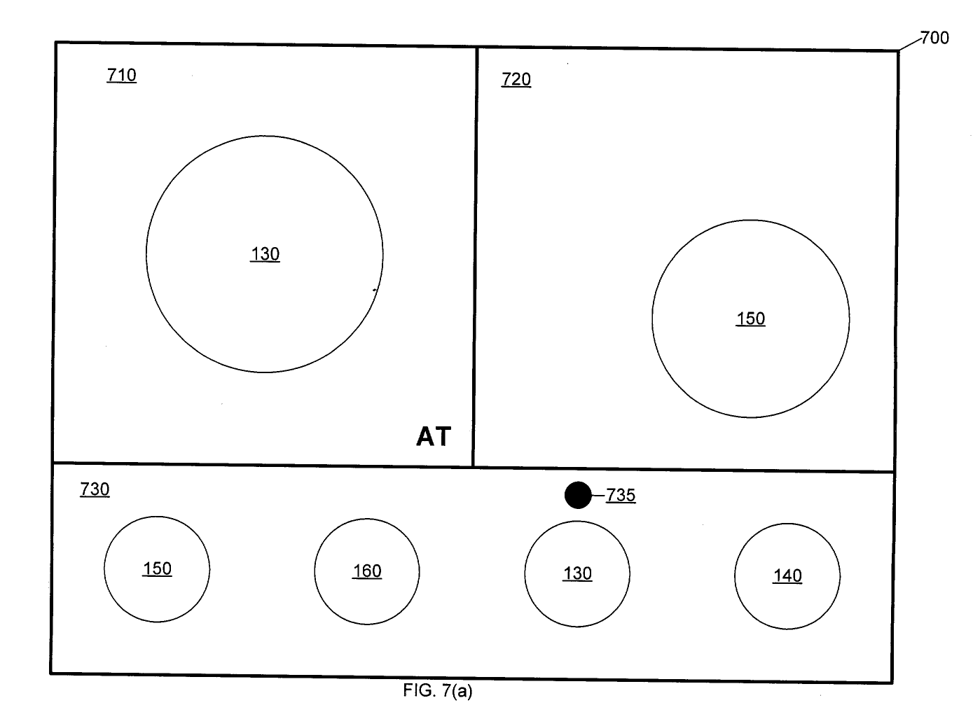

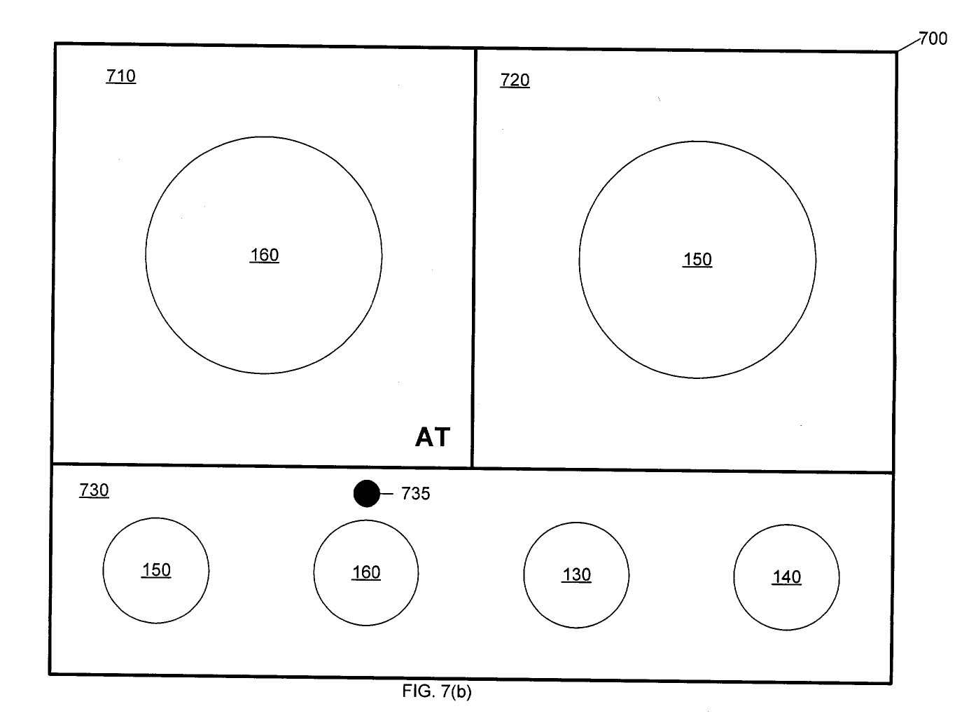

FIG. 7(a) shows a display unit 700 with an auto-tracking window 710, a virtual camera window 720, and a panoramic window 730. In the embodiment of FIG. 7(a), auto-tracking windows include “AT” in the bottom right corner of the window. In other embodiment auto-tracking windows can be marked using different window border colors or other indicators. Auto-tracking window 710 is configured to track the active speaker (i.e. on-site participant 130). Some embodiments of the present invention can also include status markers in a panoramic window. For example, in FIG. 7(a) a circular status marker 735 located above on-site participant 130 is used to indicate that on-site participant 130 is the active speaker. Status markers can be used independently of auto-tracking windows and virtual camera windows. In FIG. 7(b), on-site participant 160 has become the active speaker. Thus, auto-tracking window 710 displays on-site participant 160 and circular status marker 735 is placed over on-site participant 160. In some embodiments of the present invention status markers data is sent separately from the video data. In these embodiments status markers can be activated or deactivated independently in different windows. However, in other embodiments the status markers are overlayed on the video data to conserve bandwidth. In these embodiments, the status markers are activated for all windows or deactivated for all windows. In other embodiments, some status markers are overlayed on the video data while other status markers are transmitted independently.

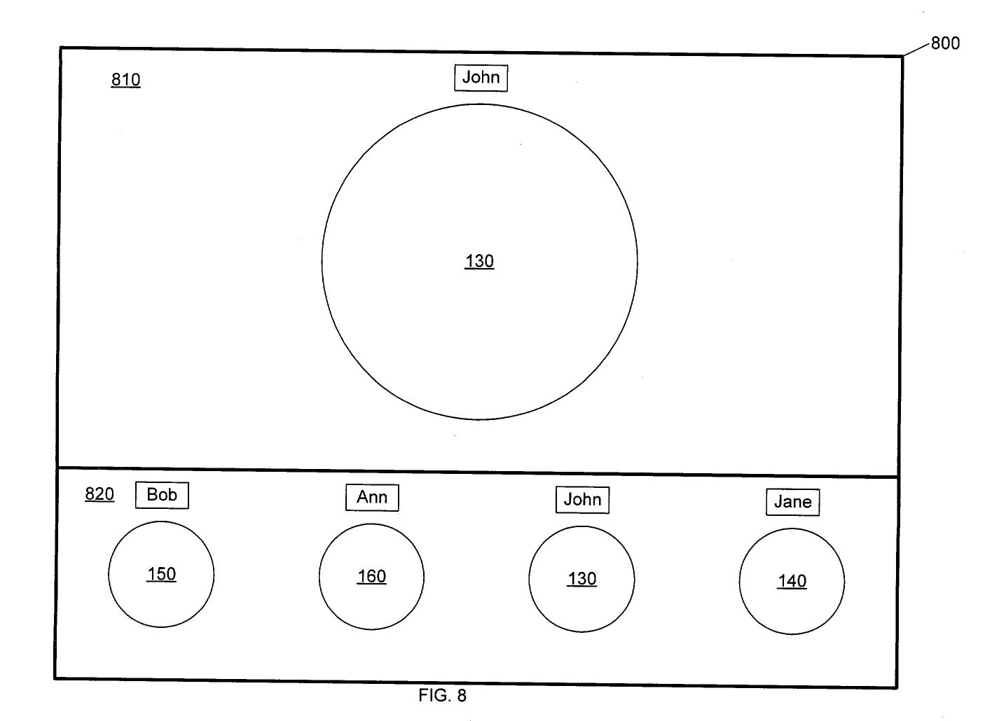

FIG. 8 illustrates a feature found in many embodiments of the present invention that support object tracking. Specifically, on-site participants can enter their names into the video conference system. The video conference system treats the name as a status marker that is attached to the on-site participant (which is simply an object to the object tracking system). The names of the on-site participants are then displayed near the participants in the panoramic window and optionally auto-tracking windows and virtual camera windows. On-site participants 130, 140, 150, and 160 are named John, Jane, Bob, and Ann, respectively. Thus, as illustrated in FIG. 8, the names of the on-site participants are displayed over the on-site participants in panoramic window 820. Similarly, because the virtual camera view of virtual-camera window 810 includes on-site participant 130, the name (John) of on-site participant 130 is displayed in virtual camera window 810.

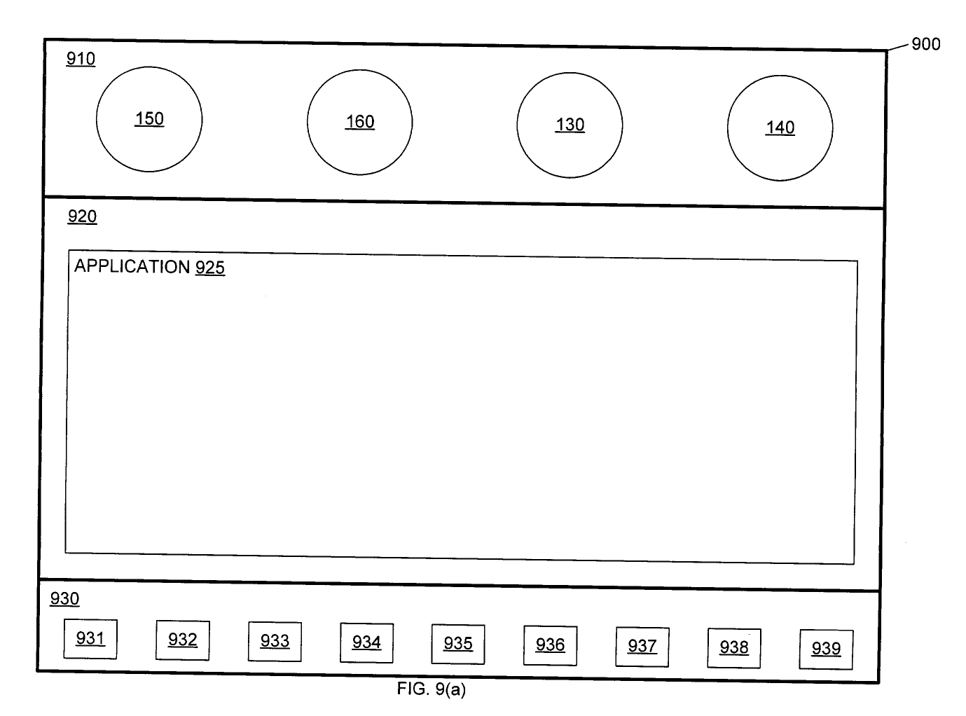

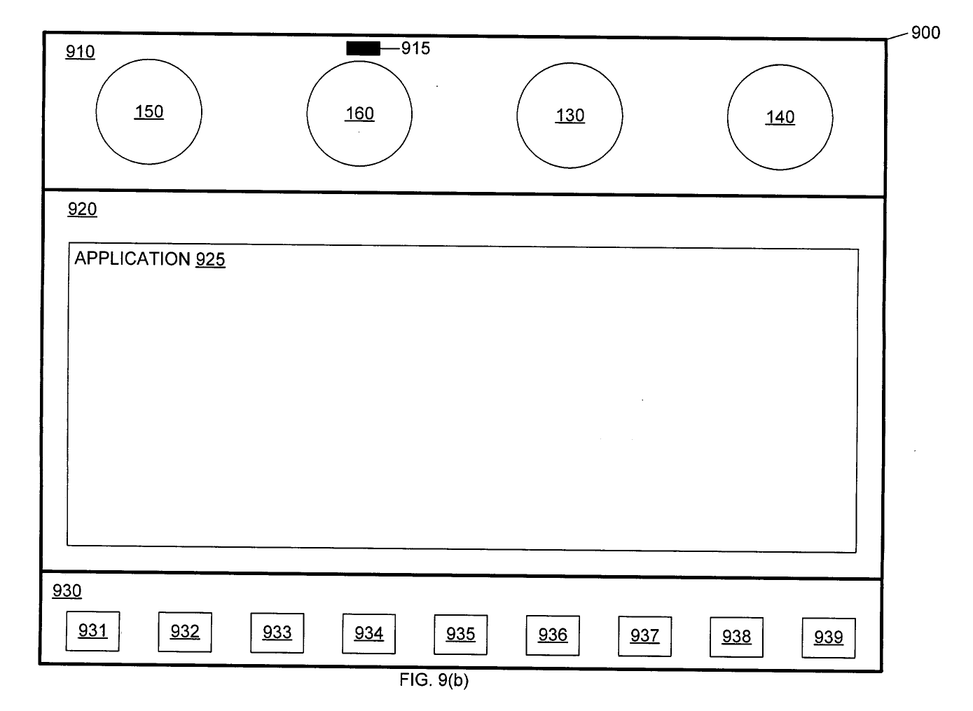

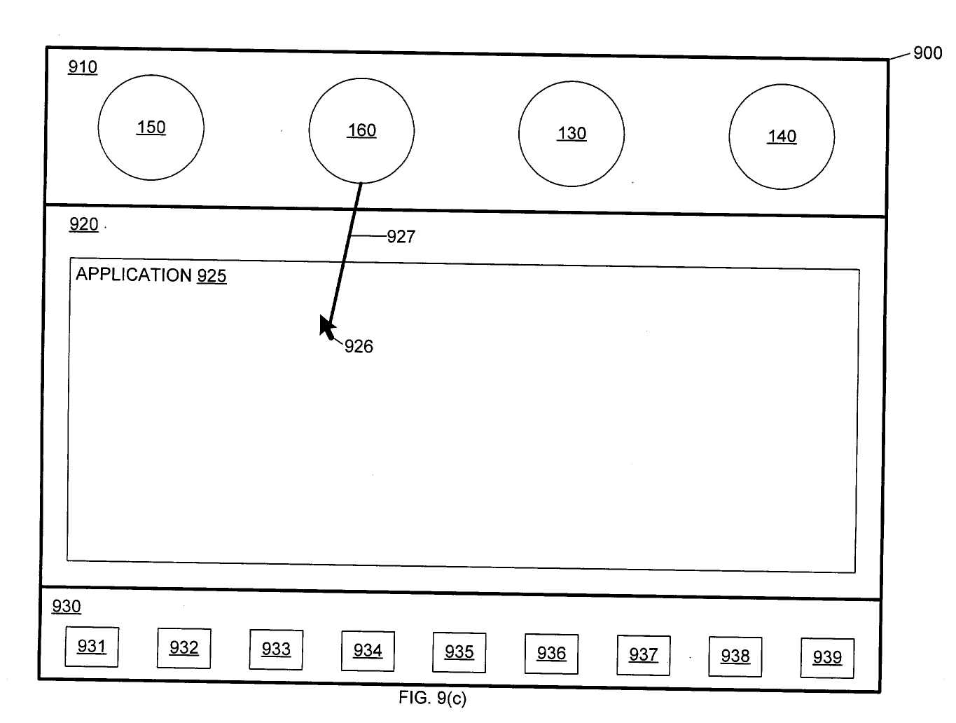

Some embodiments of the present invention also include application windows. Application windows display an application, such as a word processor, a spreadsheet, a graphics program, etc. which can be viewed and edited by the participants of the video conference. FIG. 9(a) shows a display unit 900 with a panoramic window 910, an application window 920, and a control window 930. For clarity, FIG. 9(a) is illustrated using panoramic view 230 of FIG. 2(b). Thus, on-site participants 150, 160, 130, and 140 are displayed from left to right in panoramic window 910 of display unit 900. Control window 930 includes various control buttons 931, 932, 933, . . . 939. Application window 920 displays an application (e.g., a computer program) 925, which can be viewed by all participants of the video conference. However, individual participants may choose not to use the application window on their own display unit. Some applications (for example a white board program) are designed for simultaneous editing by all participants of the meeting simultaneously. However most standard of the shelf applications are designed for a single application controller. As illustrated in FIG. 9(b) some embodiments of the present invention may use a status marker 915 to indicate the application controller. In FIG. 9(b) the application controller is on-site participant 160. As illustrated in FIG. 9(c), other embodiments may draw a visible link 927 between the application controller (on-site participant 160 again) and a cursor 926 in the application window.

In some embodiments of the present invention applications may-run directly on the video conferencing system. In other embodiments, the application runs on a application server or a computer that is coupled to the video conferencing system. Application control signals from the user interfaces of the video conferencing system are transmitted to the application. If a remote participant is the application controller, application control signals from the user interface of the video conferencing system of the remote participant are sent to the application via the video conferencing system used by the on-site participants.

In the various embodiments of this invention, novel structures and methods have been described for display units and control interfaces of video conferencing systems. By using a panoramic window to display a panoramic view of a meeting and additional windows such as a virtual camera window, auto-tracking window, or application window, a remote participant of a meeting gains most of the benefits of physically attending a meeting. The various embodiments of the structures and methods of this invention that are described above are illustrative only of the principles of this invention and are not intended to limit the scope of the invention to the particular embodiments described. For example, in view of this disclosure, those skilled in the art can define other video conferencing systems, panoramic windows, virtual camera windows, auto-tracking windows, application windows, control windows, user interfaces, display units, panoramic video capture devices, video processors, display processors, status markers, and so forth, and use these alternative features to create a method or system according to the principles of this invention. Thus, the invention is limited only by the following claims.

What is claimed is:

1. A video conference receiving system comprising:
a data input unit configured to receive a panoramic view of a meeting;
a display processor coupled to the data input unit;
a user interface coupled to the display processor; and
a display unit having
a panoramic window for displaying the panoramic view; and
a first virtual camera window for displaying a first portion of the panoramic view.

2. The video conference receiving system of claim 1, wherein the display unit comprises a second virtual camera window for displaying a second portion of the panoramic view.

3. The video conference receiving system of claim 1, wherein the user interface generates a plurality of panning control signals to adjust the first portion of the panoramic view displayed in the first virtual camera window.

4. The video conference receiving system of claim 1, wherein the user interface generates a zoom out control signal and a zoom in control signal to adjust the first portion of the panoramic view displayed the first virtual camera window.

5. The video conference receiving system of claim 1, wherein the user interface generates a centering control signal to adjust the first portion of the panoramic view displayed the first virtual camera window.

6. The video conference receiving system of claim 5, wherein the centering control signal is generated using the panoramic window.

7. The video conference receiving system of claim 1, wherein the display unit comprises an auto-tracking window for displaying an object from the panoramic view.

8. The video conference receiving system of claim 7, wherein the object is an on-site participant of the meeting.

9. The video conference receiving system of claim 1, wherein the object is an active speaker.

10. The video conference receiving system of claim 1, wherein the display unit comprises an application window for displaying an application.

11. The video conference receiving system of claim 1, wherein the display unit comprises a control window having a plurality of control buttons.

12. The video conference receiving system of claim 1, wherein the user interface generates a panoramic scroll signal to adjust the panoramic view displayed in the panoramic window.

13. The video conference receiving system of claim 1, wherein the user interface is integrated with the display unit.

14. The video conference receiving system of claim 13, wherein the user interface is a touch screen.

15. The video conference receiving system of claim 1, wherein the user interface comprises a computer mouse.

16. The video conference receiving system of claim 15, wherein the user interface further comprises a keyboard.

17. The video conference receiving system of claim 1, wherein the display unit further comprises a first status marker in the panoramic window.

18. The video conferencing receiving system of claim 17, wherein the first status marker indicates an active speaker.

19. The video conferencing receiving system of claim 17, wherein the first status marker is a name of an on-site participant of the meeting.

20. The video conferencing receiving system of claim 17, wherein the display unit further comprises a second status marker.

21. A method of displaying a panoramic view of a meeting, the method comprising:
displaying the panoramic view in panoramic window of a display unit; and
displaying a first portion of the panoramic view in a first virtual camera window of the display unit.

22. The method of claim 21, further comprising displaying a second portion of the panoramic view in a second virtual camera window of the display unit.

23. The method of claim 21, further comprising adjusting the first portion of the panoramic view in the first virtual camera window in response to one or more panning control signals from a user interface.

24. The method of claim 21, further comprising adjusting the first portion of the panoramic view in the first virtual camera window in response to zoom in control signal and a zoom out control signal panning control signals from a user interface.

25. The method of claim 21, further comprising centering the first portion of the panoramic view in the first virtual camera window in response to a centering control signal from a user interface.

26. The method of claim 21, further comprising displaying a second portion of the panoramic view in an auto-tracking window.

27. The method of claim 26, further comprising adjusting the second portion to track an object in the panoramic view.

28. The method of claim 27, wherein the object is a on-site participant of the meeting.

29. The method of claim 27, wherein the object is an active speaker.

30. The method of claim 21, further comprising adjusting the panoramic view displayed in the panoramic window in response to a panoramic scroll control signal.

31. The method of claim 21, further comprising placing a first status marker in the panoramic window.

32. The method of claim 31, wherein the first status marker indicates an active speaker.

33. The method of claim 31, further comprising placing a second status marker in the panoramic window.

34. The method of claim 31, wherein the first status marker is a name of a on-site participant of the meeting.

35. A video conference receiving system comprising:
a data input unit configured to receive a panoramic view of a meeting;
a display processor coupled to the data input unit;
a user interface coupled to the display processor; and
a display unit having
a panoramic window for displaying the panoramic view; and
a first auto tracking window for displaying an object from the panoramic view.

36. The video conference receiving system of claim 35, wherein the object is on-site participant of the meeting.

37. The video conference receiving system of claim 35, wherein the object is an active speaker.

38. The video conference receiving system of claim 35, wherein the data input unit is configured to receive object tracking data for the object.

39. The video conference receiving system of claim 35, further comprising an object tracking unit for tracking the object in the panoramic view.

40. The video conference receiving system of claim 35, wherein the display unit further comprises a first virtual camera window for displaying a first portion of the panoramic view.

41. A method of displaying a panoramic view of a meeting, the method comprising:
displaying the panoramic view in panoramic window of a display unit; and
displaying an object from the panoramic view in a first auto-tracking window of the display unit.

42. The method of claim 41, further comprising:
receiving object tracking data regarding the object; and
updating the first auto-tracking window using the object tracking data.

43. The method of claim 41, further comprising:
performing object tracking to generate object tracking data regarding the object; and
updating the first auto-tracking window using the object tracking data.

44. The method of claim 41, wherein the object is a on-site participant of the meeting.

45. The method of claim 41, wherein the object is an active speaker.

46. The method of claim 41, further comprising displaying a first portion of the panoramic view in a first virtual camera window of the display unit.

47. A video conference receiving system comprising:
a data input unit configured to receive a panoramic view of a meeting;
a display processor coupled to the data input unit;
a user interface coupled to the display processor; and
a display unit having
a panoramic window for displaying the panoramic view; and
an application window for displaying an application.

48. The video conference receiving system of claim 47 further comprising a data output unit coupled to the user interface, wherein the data output unit sends application control signals from the user interface to the application.

49. The video conference receiving system of claim 47, wherein the data input unit receives application control signals for the application.

50. The video conference system of claim 47, wherein the display unit further comprises a first virtual camera window for displaying a first portion of the panoramic view.

51. The video conference system of claim 47, wherein the display unit further comprises a status marker in the panoramic window.

52. The video conference system of claim 51, wherein the status marker indicates an application controller.

53. The video conference system of claim 47, wherein the display unit comprises a cursor in the application window.

54. The video conference system of claim 53, wherein the display unit comprises a visible link from an application controller to the cursor.

55. A method of displaying a panoramic view of a meeting, the method comprising:
displaying the panoramic view in panoramic window of a display unit; and
displaying an application in an application window of the display unit.

56. The method of claim 55 further comprising receiving application control signals from a remote participant of the meeting.

57. The method of claim 55, further comprising transmitting application control signals from a user interface.

58. The method of claim 55, further comprising:
receiving an identity of the application controller;
placing a status marker near the application controller in the panoramic view.

59. The method of claim 55, further comprising:
determining an identity of the application controller;
placing a status marker near the application controller in the panoramic view.

60. The method of claim 55, further comprising:
receiving an identity of the application controller; and
drawing a visible link from the application controller in the in the panoramic window to a cursor in the application window.

61. The method of claim 55, further comprising:
determining an identity of the application controller; and
drawing a visible link from the application controller in the in the panoramic window to a cursor in the application window.

62. The method of claim 55, further comprising displaying a first portion of the panoramic view in a first virtual camera window of the display unit.

63. A video conference receiving system comprising:
a data input unit configured to receive a panoramic view of a meeting;
a display processor coupled to the data input unit;
a user interface coupled to the display processor; and
a display unit having
a panoramic window for displaying the panoramic view; and
a first status marker in the panoramic window attached to a first object in the panoramic view.

64. The video conference receiving system of claim 1, wherein the first status marker is an active speaker marker the first object is an active speaker.

65. The video conference receiving system of claim 1, wherein the first object is a first on-site participant and the first status marker is a name of the first on-site participant.

66. The video conference receiving system of claim 1, wherein the first object is an application user and the first status marker is an application user marker.

67. The video conference receiving system of claim 61, wherein the display unit further comprises a second status marker attached to a second object in the panoramic window.

68. The video conference system of claim 67, wherein the first object is a first on-site participant, the second object is a second on-site participant, the first status marker is a name of the first on-site participant, and the second status marker is a name of the second on-site participant.

69. The video conference system of claim 61, wherein the display unit further comprises an auto-tracking window for displaying the first object from the panoramic view.

70. The video conference system of claim 61, wherein the display unit further comprises an auto-tracking window for displaying a second object from the panoramic view.

71. The video conference system of claim 61, wherein the display unit further comprises a virtual camera window for displaying a portion of the panoramic view.

72. The video conference system of claim 61, wherein the display unit further comprises an application window for displaying an application.

73. A method of displaying a panoramic view of a meeting, the method comprising:
displaying the panoramic view in a panoramic window of a display unit; and
displaying a first status marker in the panoramic window, wherein the first status marker is attached to a first object in the panoramic view.

74. The method of claim 73, wherein the first object is an active speaker and the first status marker is an active speaker marker.

75. The method of claim 73, wherein the first object is an application user and the first status marker is an application user marker.

76. The method of claim 73, wherein the first object is a first on-site participant and the first status marker is a name of the first on-site participant.

77. The method of claim 73, further comprising displaying a second status marker in the panoramic window, wherein the second status marker is attached to a second object in the panoramic view.

78. The method of claim 73, further comprising displaying a first portion of the panoramic view in a first virtual camera window of the display unit.

79. The method of claim 73, further comprising displaying the first object in an auto-tracking window of the display unit.

80. The method of claim 73, further comprising displaying a second object in an auto-tracking window of the display unit.

81. The method of claim 73, further comprising displaying an application in an application window of the display unit.
